(19) United States
(12) Patent Application Publication
(10) Pub. No.: US 2010/0182308 A1
(43) Pub. Date: Jul. 22, 2010

(54) LIGHT BAR INCLUDING TURNING MICROSTRUCTURES AND CONTOURED BACK REFLECTOR

(76) Inventors: Robert L. Holman, Evanston, IL (US); Matt Sampsell, Chicago, IL (US); Russell Wayne Gruhlke, Milpitas, CA (US); Marek Mienko, San Jose, CA (US); Gang Xu, Cupertino, CA (US); Ion Bita, San Jose, CA (US)

Correspondence Address: KNOBBE, MARTENS, OLSON & BEAR, LLP, 2040 MAIN STREET, FOURTEENTH FLOOR, IRVINE, CA, 92614, US

(21) Appl. No.: 12/444,156

(22) PCT Filed: Oct. 5, 2007
(86) PCT No.: PCT/US2007/021375

§ 371 Date: Mar. 25, 2010

Related U.S. Application Data
(60) Provisional application No. 60/850,099, filed on Oct. 6, 2006.

(51) Int. Cl. G06F 3/038; F21V 7/04; H01J 9/00

(52) U.S. Cl. 345/214; 362/609; 445/23

(57) ABSTRACT

An illumination apparatus includes a light bar, a plurality of indentations in the light bar on a first side of the light bar, and a contoured reflective surface including a plurality of protruding surface portions, such that the surface portions reflect light transmitted through sloping sidewalls of the indentations. The light bar has a first end for receiving light from a light source. The light bar includes material that supports propagation of the light along the length of the light bar. The turning microstructure is configured to turn at least a substantial portion of the light incident on the first side and to direct the portion of light out the second opposite side of the light bar. The protrusions on the contoured reflective surface and the indentations on the light bar can have complimentary shapes and/or aligned in certain embodiments.

### CROSS-REFERENCE TO RELATED APPLICATIONS

This application claims priority benefit under 35 U.S.C. §119(e) to U.S. Provisional Application Ser. No. 60/850,099, filed Oct. 6, 2006, entitled “Illumination Assemblies Comprising Light Bars,” which is incorporated herein by reference in its entirety.

### BACKGROUND

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In some embodiments, an illumination apparatus comprises a light bar having a first end for receiving light from a light source, the light bar including material that supports propagation of the light along the length of the light bar; a plurality of indentations in the light bar on a first side of the light bar, the indentations configured to turn at least a substantial portion of the light incident on the first side and to direct the portion of light out a second opposite side of the light bar, the indentations including sloping sidewalls that reflect light by total internal reflection out the second opposite side of the light bar; and at least one contoured reflective surface including a plurality of protruding surface portions, the protruding surface portions reflecting light transmitted through the sloping sidewalls.

In some embodiments, a method of manufacturing an illumination apparatus comprises providing a light bar having a first end for receiving light from a light source, the light bar including material that supports propagation of the light along the length of the light bar; providing a plurality of indentations in the light bar on a first side of the light bar, the indentations configured to turn at least a substantial portion of the light out a second opposite side of the light bar, the indentations including sloping sidewalls that reflect light by total internal reflection out the second opposite side of the light bar; and disposing at least one contoured reflective surface including a plurality of protruding surface portions, the protruding surface portions reflecting light transmitted through the sloping sidewalls.

In some embodiments, an illumination apparatus comprises means for supporting propagation of the light along the length of the propagation supporting means, the light propagation supporting means including means for receiving light from a means of producing light; means for turning light incident on a first side of the propagation supporting means and directing the portion of light out a second opposite side of the propagation supporting means, the turning means disposed on the first side of the propagation supporting means, the turning means including first means for deflecting light that reflects light by total internal reflection out the second opposite side of the propagation supporting means; and means for reflecting light including a second means for deflecting light, the second light deflecting means reflecting light transmitted through the first light deflecting means.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8A is a cross section of a portion of an embodiment of a display device including an illumination apparatus comprising a light guide panel dispose forward of a modulator array.

FIG. 8B is a perspective view of a portion of a display device including an illumination apparatus comprising a light emitter, a light bar, and a light guide panel.

FIG. 9A is a cross section of a portion of another display device including an illumination apparatus comprising reflective surfaces disposed about a light bar.

FIG. 9B is a top plan view of a portion of the display device of FIG. 9A.

FIG. 9C is a close-up view of a reflective surface disposed with respect to the light bar which comprises turning features.

FIG. 9D is a schematic representation of a light bar including diffractive turning features and a reflective surface disposed with respect thereto.

FIG. 9E is a schematic representation of a reflective surface having diffractive turning features disposed with respect to a light bar.

FIG. 10A is another cross section of a portion of the display device of FIG. 9A showing the intensity distribution of the light injected into the light guide panel.

FIG. 10B is another top plan view of a portion of the display device of FIG. 9A also showing the intensity distribution of the light injected into the light guide panel.

FIG. 11A is a cross section of a portion of another display device including a light bar with retro-reflector disposed above and below a light bar.

FIG. 11B is a top plan view of a portion the display device of FIG. 11A showing the intensity distribution resulting from the retro-reflectors.

FIG. 12A is a schematic representation of a light bar including turning features having metallization disposed thereon.

FIG. 12B is a schematic representation of a light bar including turning features and a contoured reflector disposed with respect thereto.

FIG. 13A is a cross-sectional view of an example embodiment of an illumination apparatus comprising a tapered light bar.

FIG. 13B is a cross-sectional view of an example embodiment of an illumination apparatus that includes a tapered coupler between a light bar and a light panel.

### DETAILED DESCRIPTION OF THE PREFERRED EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Some embodiments may comprise contoured reflective surfaces disposed with respect to the turning features of a light bar. The contour reflective surfaces may comprise a plurality of protrusions while the turning microstructure on the light bar may comprises a plurality of indentations. The protrusions on the contoured reflective surface and the indentations on the light bar can have complimentary shapes and/or aligned in certain embodiments.

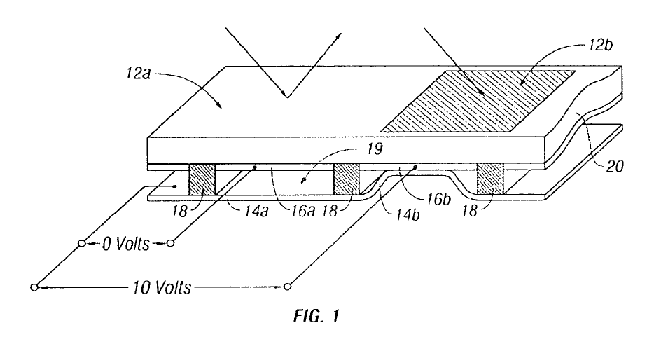

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

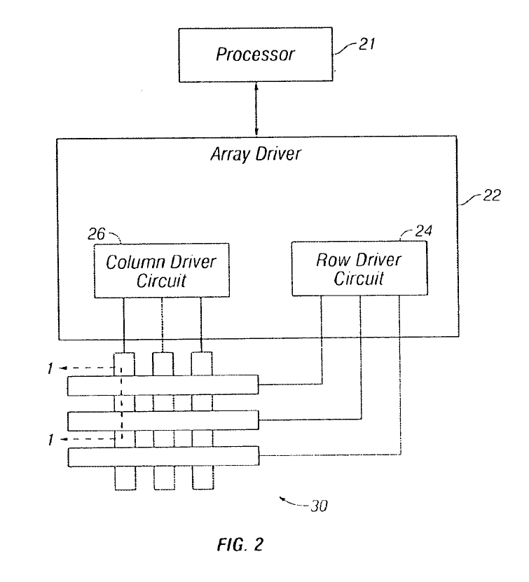

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

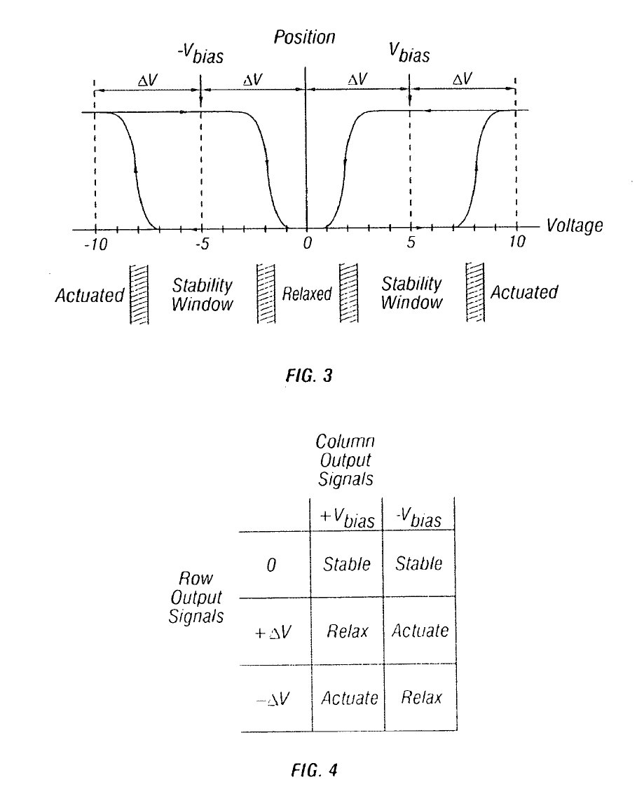

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

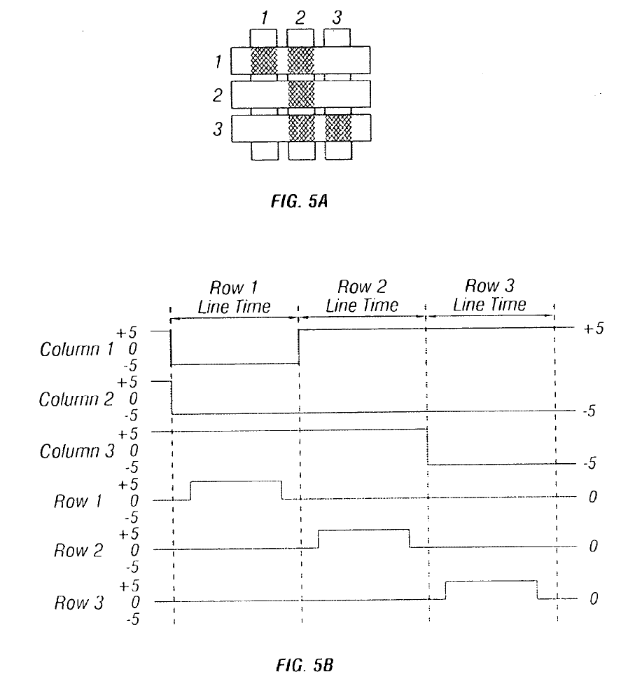

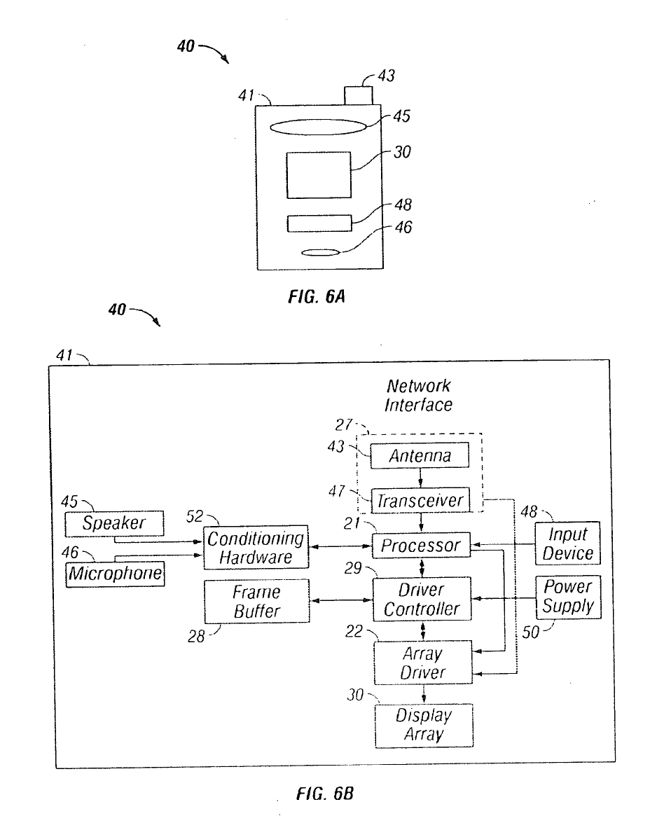

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to V_{bias}, and the appropriate row to +ΔV, which may correspond to −5 volts and +5 volts, respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

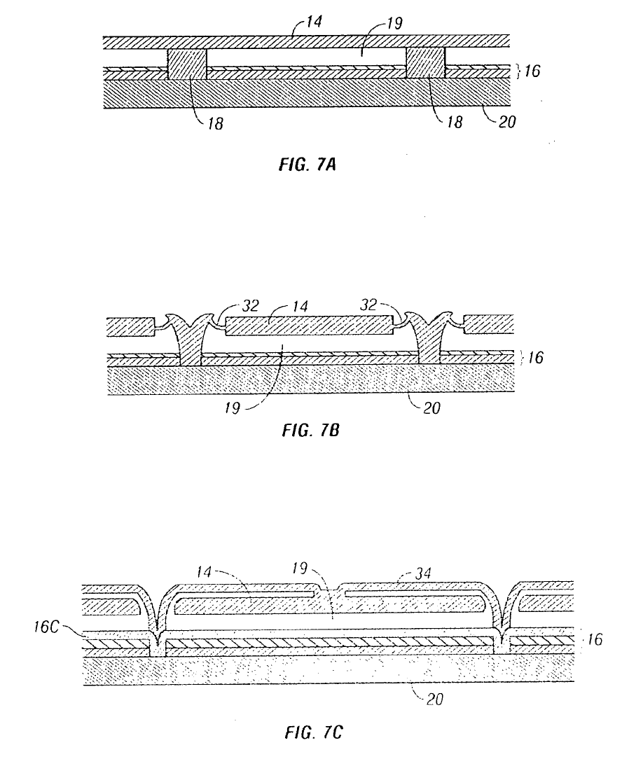

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28 and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment, the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, or a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell including a plastic solar cell, and solar-cell paint. In another embodiment, power supply 50 is configured to receive power from a wall outlet.

In some embodiments, control programmability resides, as described above, in a driver controller which can be located in several places in the electronic display system. In some embodiments, control programmability resides in the array driver 22. Those of skill in the art will recognize that the above-described optimizations may be implemented in any number of hardware and/or software components and in various configurations.

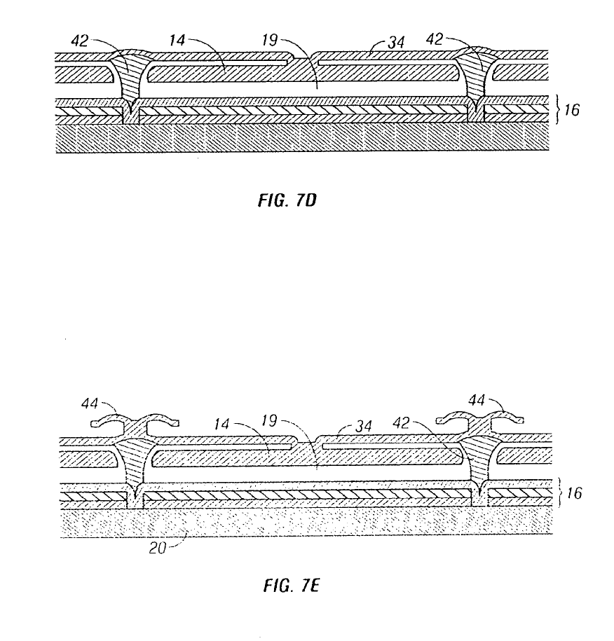

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C, as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As described above, light incident on an interferometric modulator is either reflected or absorbed via constructive or destructive interference according to an actuation state of one of the reflective surfaces. Such interferometric phenomena are highly dependent on both the wavelength and the angle of incidence of the incident light. This complicates the design of an illumination apparatus that provides artificial lighting to a display device comprising an interferometric modulator or array thereof. The illumination system may be designed for the unique characteristics of the particular interferometric modulator or modulators in the display device.

In some embodiments, an illumination system comprises a light source, a light injection system, a light guide panel, and a light “turning” film. The light injection system transforms light from a point source (e.g., a light emitting diode (LED)) into a line source. A light bar having turning features may be used for this purpose. Light injected into the light bar propagates along the length of the bar and is ejected out of the bar over the length of the bar. This light is then spread across a wide area and directed onto an array of display elements. A light guide panel also having turning features thereon may be used for this purpose. The light ejected from the light bar is coupled into an edge of the light guide panel and propagated within the light guide panel. Turning features eject the light from the panel over an area corresponding the plurality of display elements.

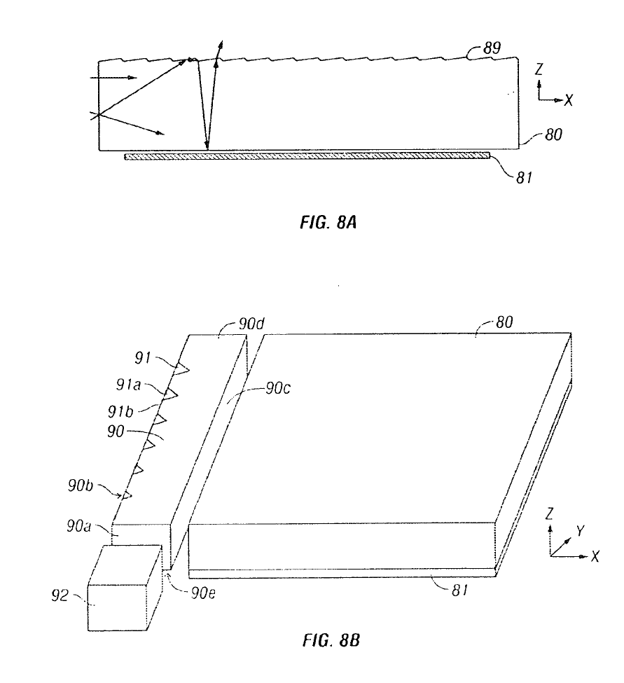

FIG. 8A is a cross-sectional view of a display device including an illumination system that comprises a light guide panel 80 disposed with respect to a plurality of display elements 81. The light guide panel 80 includes a turning film 89 comprising, for example, a prismatic film. As described above and shown in FIG. 8A, the turning film 89 directs light propagating through the light guide panel 80 into the display elements 81. Light reflected from the display elements 81 is then transmitted through and out of the light guide panel 80.

FIG. 8B illustrates a display device comprising an illumination apparatus that comprises a light bar 90 and a light guide panel 80. The light bar 90 has a first end 90a for receiving light from a light emitter 92. The light emitter 92 may comprise a light emitting diode (LED), although other light sources are also possible. The light bar 90 comprises substantially optically transmissive material that supports propagation of light along the length of the light bar 90. Light emitted from the light emitter 92 propagates into the light bar 90. The light is guided therein, for example, via total internal reflection at sidewalls thereof, which form interfaces with air or some other surrounding fluid or solid medium. Accordingly, light travels from the first end 90a to a second end 90d of the light bar 90. The light guide panel 80 is disposed with respect to the light bar 90 so as to receive light that has been turned by the turning microstructure and directed out of the light bar 90. In certain embodiments, for example, the light guide panel 80 includes a prismatic film 89 that reflects light from the light bar 90 into a plurality of display elements 81 (e.g., a plurality of spatial light modulators, interferometric modulators, liquid crystal elements, etc.).

The light bar 90 includes a turning microstructure on at least one side, for example, the side 90b that is substantially opposite the light guide panel 80. The turning microstructure is configured to turn at least a substantial portion of the light incident on that side 90b of the light bar 90 and to direct that portion of light out of the light bar 90 (e.g., out side 90c) into the light guide panel 80. In certain embodiments, the illumination apparatus further comprises a coupling optic (not shown) between the light bar 90 and the light guide panel 80. For example, the coupling optic may collimate, magnify, diffuse, change the color, etc., of light propagating from the light bar 90.

The turning microstructure of the light bar 90 comprises a plurality of turning features 91 having facets 91a (which may be referred to as faceted turning features or faceted features), as can be seen in FIG. 8B. The features 91 shown in FIG. 8B are schematic and exaggerated in size and spacing therebetween. As illustrated, the turning microstructure is integrated with the light bar 90. For example, some or all of the faceted features 91 of the turning microstructure could be formed in a film that is formed on, or laminated to, the light bar 90. Alternatively, the light bar 90 may be molded with the turning features 91 formed therein by molding.

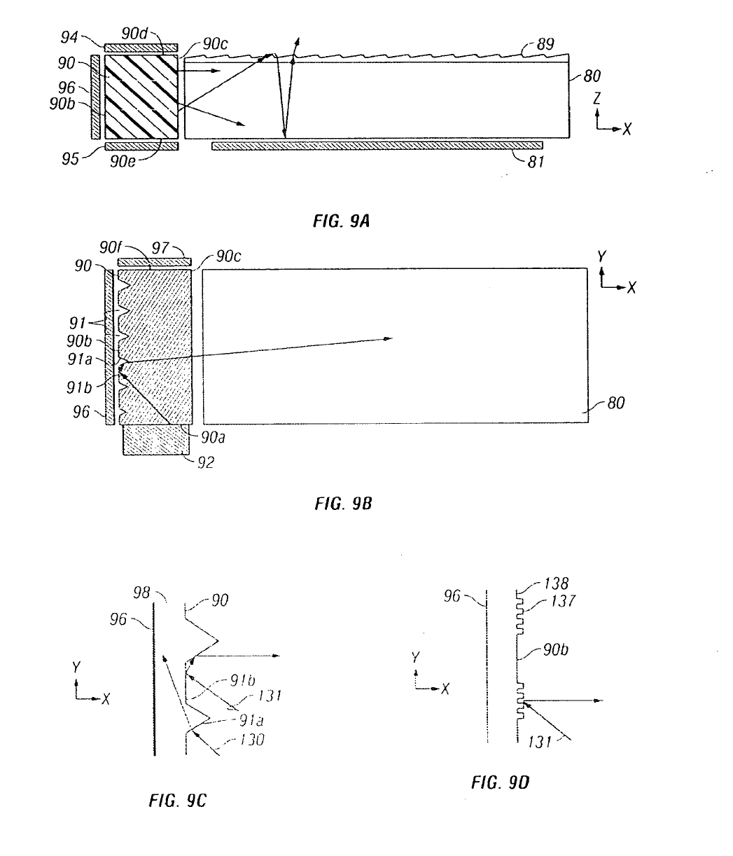

The facets 91a or sloping surfaces are configured to direct or scatter light out of the light bar 90 towards the light guide panel 80. Light may, for example, reflect by total internal reflection from a portion 91b of the sidewall of the light bar 90 parallel to the length of the light bar 90 to one of the sloping surfaces 91a. This light may reflect from the sloping surface 91a in a direction toward the light guide panel 80. (See also FIGS. 9B and 9C) In the embodiment illustrated in FIG. 8B, the turning microstructure comprises a plurality of grooves. Specifically, the turning microstructure comprises a plurality of triangular grooves having substantially triangular cross-sections. The triangular grooves illustrated in FIG. 8B have cross-sections with the shape of an isosceles triangle, although other shapes are also possible. In certain embodiments, at least one of the sides 91a of the triangular grooves is oriented at an angle of between about 35° and 55° with respect to the normal to the side 90b. In various embodiments, at least one of the sides 91a of the triangular groove is oriented at an angle of between about 45° and 55° with respect to the normal to the side 90b. In various embodiments, at least one of the sides 91a of the triangular groove is oriented at an angle of between about 48° and 52° with respect to the normal to the side 90b. In various embodiments, at least one of the sides 91a of the triangular groove is oriented at an angle of between about 39° and 41° with respect to the normal to the side 90b. Triangular grooves with other angles are also possible. The orientation of the sides 91a can affect the distribution of light exiting the light bar 90 and entering the light guide panel 80.

In some embodiments, the turning microstructure has a parameter that changes with distance, d, from the first end 90a of the light bar 90 and/or the light source 92. In some embodiments, the parameter of the microstructure that changes with distance, d, from the first end 90a of the light bar 90 and/or the light source 92 is size, shape, density, spacing, position, etc. In certain such embodiments, the turning microstructure has a size that, on average, increases with distance, d, from the light source 92. For example, the turning microstructure in some embodiments has a width (e.g., parallel to y-axis) that, on average, increases with distance, d, from the light source 92. In another example, the turning microstructure in some embodiments has a depth (e.g., parallel to the x axis) that, on average, increases with distance, d, from the light source 92. The turning features 91 illustrated in FIG. 8B increase in both depth and width, while the angles of the facets 91a or sloping sidewalls remain substantially constant. In some embodiments, one or more other parameters of the turning microstructure may change, such as shape and angle.

In certain embodiments, the turning microstructure has a density, ρ, of turning features 91 that remains substantially the same with distance, d, from the light source. For example, in FIG. 8B the plurality of triangular grooves 91 are approximately equally spaced from each other. In certain such embodiments, the turning microstructure has a density, ρ, that increases with distance, d, from the first end 90a of the light bar 90 and/or the light source 92. For example, the turning microstructure in some embodiments has a spacing (e.g., along the y-axis) that, on average, increases with distance, d, from the first end 90a of the light bar 90 and/or the light source 92.

In some embodiments, the light bar 90 has a turning efficiency that determines the amount of light turned out of the light bar 90 compared to the amount of light that continues to be guided within the light bar 90. In certain such embodiments, the turning efficiency increases with distance, d, from the first end 90a of the light bar 90 and/or the light source 92.

As illustrated in FIGS. 9A and 9B, the illumination apparatus may additionally comprises one or more reflectors or reflecting portions 94, 95, 96, 97 disposed with respect to the sides (top 90d, bottom 90e, left 90b, and/or back 90f) of the light bar 90. In various embodiments, the reflective surfaces 94, 95, 96, and 97 may comprises planar reflectors, although other shapes are possible. Additionally, the reflectors may comprise diffuse or specular reflectors, although diffuse reflectors may offer the advantage of altering the angle that reflected light returning to the light bar 90 propagates therein. In certain embodiments, the reflecting surfaces comprise metal, reflecting paint, or other reflective material. In some embodiments, a dielectric multilayer film (e.g., an interference coating) may be used. An interference coating constructed from dielectric films may advantageously reflect a greater portion of incident light than a metal reflective surface, as metal surfaces may absorb a portion of incident light. Reflective surfaces comprising other reflective materials may also be used. Additional materials are discussed below.

Additionally, although separate reflectors are shown in FIGS. 9A and 9B, these reflectors may be integrated on one or more common elements. For example, a metal shroud having a “C” shaped cross section may be disposed about the light bar 90. The metal surface on this metal shroud may provide the reflective surface portions 94, 95, 96, above, below, and to the side of the light bar 90. The metal shroud may or may not include an end portion that provides the reflective surface portion 97 disposed at the end of the light bar 90. In other embodiments, two or more of the reflective surface portions 94, 95, 96, 97 may be integrated on a common structure. Such a structure may comprise other materials. In some embodiments, this structure may be coated with reflective material. Other configurations are possible.

The reflective surfaces are disposed with respect to the light bar 90 to direct light that would otherwise be transmitted out of the top 90d, bottom 90e, left 90b, and back 90f sides back into the light bar 90. In particular, the reflector 97 directs the light propagating through the light bar 90 that would be directed out the back end (or second end) 90f of the light bar 90 back towards the light source 92. Similarly, reflectors 94 and 95 direct the light propagating through the light bar 90 that would be directed out the top 90d or the bottom 90e of the light bar 90 back into the light bar 90. This light propagates within the light bar 90 where it may be directed towards the light guide panel 80. In some cases, the light redirected back into the light bar 90 is ultimately incident on the turning microstructure and is thereby directed to the light guide panel 80.

The end reflector 97 is particularly important. This reflector 97 is disposed with respect to the end surface 90f of the light bar 90 such that light propagating though the length of the light bar 90 is returned back into the light bar 90 for another pass. The light reflected back by the end reflector 97 may, for example, be incident on a turning feature 91 and thereby directed into the light guide panel 80 on this second pass.

The reflector 96 disposed with respect to the first side 90b of the light bar 90 reflects the light propagating through the light bar 90 that directed out of the first side 90b of the light bar 90 back into the light bar 90. Preferably, a substantial portion of that light is turned and is directed towards the light guide panel 80 by the turning microstructure. As such, in certain embodiments, at least one of the sides 91a of the triangular grooves is oriented at an angle of between about 45° and 55° with respect to the normal to the side 90b. In some embodiments, at least one of the sides 91a of the triangular groove is oriented at an angle of between about 48° and 52° with respect to the normal to the side 90b. Triangular grooves with other angles are also possible. It will be appreciated that in embodiments without such a reflector 96, a right triangle or simply a plurality of grooves having a side angled towards the light source 92 instead of an isosceles triangle may be appropriate.

FIG. 9C illustrates rays propagating through the first side 90a to the side reflector 96. However, the reflector 96 should be close enough that light transmitted through the light bar 90, for example the ray 130 that hits a first surface 91a of the faceted turning feature 91 at an angle such that it is not totally internally reflected, is reflected back into the light bar 90. The ray 131 of FIG. 9C is incident to a second surface 91b of the faceted turning feature 91 at an angle such that it undergoes total internal reflection and can be turned by the second surface 91b of the facet 91. As illustrated, the sloped surface 91a of an adjacent faceted turning feature 91 completes the turning of ray 131 such that it is often redirected towards the opposite side 90c of the light bar 90. In FIG. 9C, the reflector 96 is spaced from the light bar 90 such that it does not interfere with the total internal reflection of the light bar 90. For example, the reflector 96 may be separated from the light bar 90 by a gap 98 (e.g., an air gap). The configuration of the reflector 96, for example, does not substantially interfere with the turning of the ray 131 as the reflector 96 is separated from the light bar 90 by a gap 98.

FIG. 9D illustrates another embodiment, wherein the turning features comprise diffractive features 137 rather than prismatic features (such as shown in FIG. 9C). In various preferred embodiments, the diffractive features 137 are configured to redirect light (e.g., ray 131) incident thereon at an angle through which light propagates within the light bar 90 out the second side 90c of the light bar 90 and into the light guide panel 80. Light may propagate along the length of the light bar 90, for example, via total internal reflection at grazing angles, e.g., of about 40° or more (as measured from the normal to sidewalls of the light bar 90). In some embodiments, this angle may be at or above the critical angle established by Snell's law. The diffracted ray 131 is redirected near normal to the length of the light bar 90. The diffractive features 137 may comprise surface or volume diffractive features. The diffractive features 137 may be included on a diffractive turning film 138 on the first side 90b of the light bar 90. The diffractive features may comprise holographic features. Likewise the diffractive turning film may comprise a hologram or holographic film in some embodiments. The diffractive microstructure may be on top, bottom, or a side of the light bar 90. Additionally, the diffractive features may extend continuously along the length of the light bar 90. FIG. 9D also shows the side reflector 96 disposed to reflect rays that pass through the first side 90b of the light bar 90.

FIG. 9E illustrates an embodiment wherein the side reflector 96 includes diffractive features 139. These diffractive features 139 may also be configured to redirect light (e.g., ray 133) incident thereon at an angle through which light escapes the light bar 90. As shown, this light ray 133 is redirected by the diffractive feature 139 back into the light bar 90 and is on a trajectory to exit the light bar 90 through the second side 90c of the light bar 90, and be injected into the light guide panel 80. This diffracted ray 133 is redirected near normal to the length of the light bar 90.

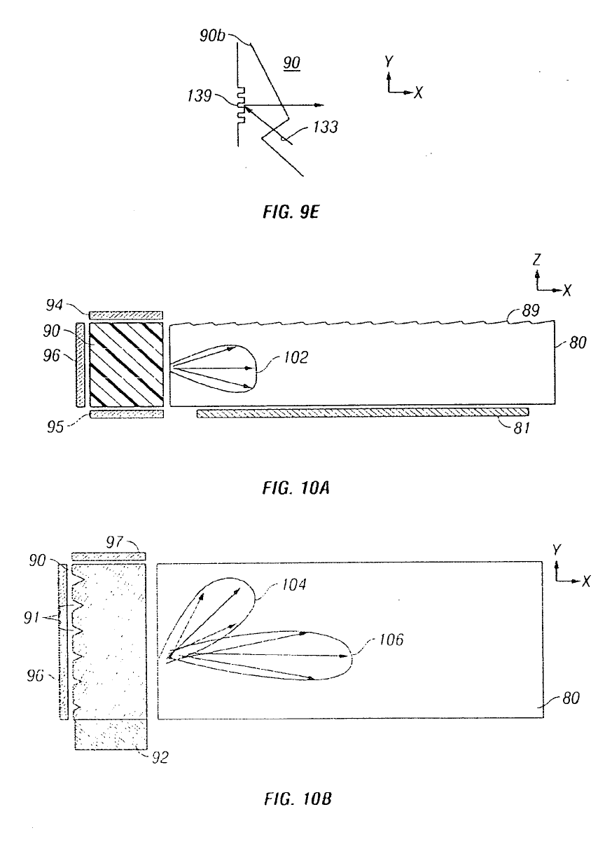

In various embodiments, a substantial portion of the light output from the light bar 90 is collimated and similarly the light injected into the light guide panel 80 is collimated. To illustrate how collimated light is introduced into the light guide panel 80, FIGS. 10A and 10B show example light rays exiting a small localized region of the light bar 90. Rays emanating from only a single small localized region of the light bar 90 are shown merely to simplify illustration of the effects of the features 91 and reflectors 94, 95, 96, 97, although one can extrapolate to larger regions of the light bar 90 and light guide panel 80.

For the embodiments shown in FIGS. 10A and 10B, which include the planar reflectors 94, 95, 96, 97, the angular distribution of the light rays shown propagating into the light guide panel 80 consists of two primary lobes 104, 106. In FIG. 10B, the lobe 106 propagates from the light bar 90 generally perpendicularly to the length of the light bar 90 and is generally collimated. In contrast, the lobe 104 propagates from the light bar 90 at an angle less than 90° from the normal to the length of the light bar 90. This lobe 104 is located on a side farther from the light source 92 and closer to the far end 91f of the light bar 90. In FIG. 10A, the lobe 102 is a side view of the lobes 104, 106 of FIG. 10B and is generally symmetrical.

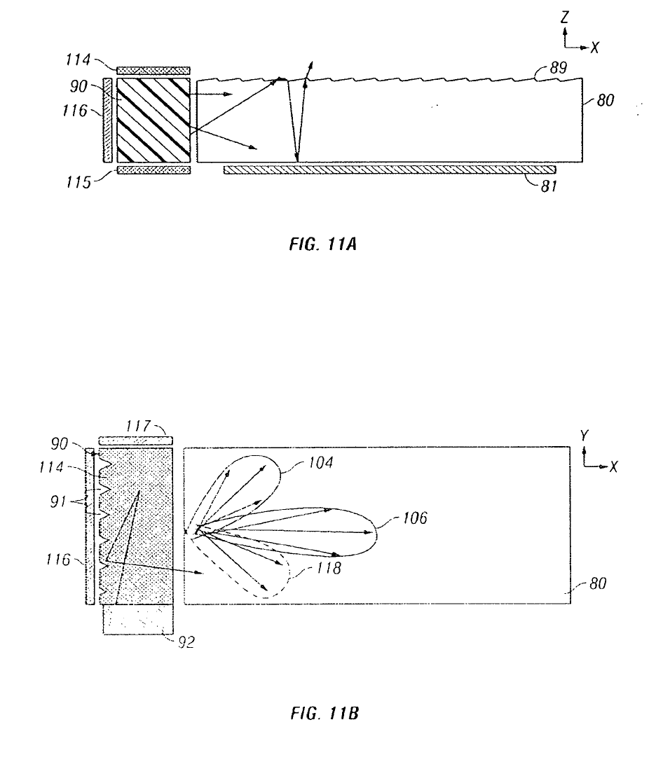

FIGS. 11A and 11B illustrate an embodiment in which the reflectors 94, 95 comprise retro reflectors 114, 115. The retro reflectors 114, 115 reflect light in such a way that the light is returned in the direction from which it came. The reflected light may be laterally displaced with respect to the incident light such that it does not retrace the same path. Retro reflectors may include microstructures that redirect the incident ray. For example, retro reflective sheets may comprise a layer of tiny refractive spheres or a reflective layer with pyramid-shaped microstructures. A retro reflective sheet may comprise, for example, a metal film or a sheet of Scotchlite® retro reflective material, available from the 3M Company in Maplewood, Minn. Other types of retro reflectors may be used.

In the embodiment shown in FIGS. 11A and 11B, a pair of retro reflectors 114, 115 are disposed with respect to the top and bottom surfaces 90d, 90e of the light bar 90 (FIG. 9A). The retro-reflectors 114, 115 increase the collimation of light emitted from the side 90c of the light bar 90 (FIG. 9A) and into the light guide panel 80. To illustrate how collimated light is introduced into the light guide panel 80, FIGS. 11A and 11B show example light rays exiting a small localized region on the side 90c the light bar 90. Rays emanating from only a single small localized region of the light bar 90 are shown merely to simplify illustration of the effects of the features 91, the reflectors 116, 117, and the retro reflectors 114, 115, although one can extrapolate to larger regions of the light bar 90 and light guide panel 80. The retro reflectors 114, 115 disposed with respect to the top and bottom 90d, 90e surfaces of the light bar 90 generate a lobe of light 118 that propagates from the light bar 90 at an angle less than 90° from the length of the light bar 90 on the same side of the normal to the length as the light emitter 92, as shown in FIG. 11B. A more symmetrical light distribution is ejected from the light bar 90, thereby helping to balance the amount of light directed into the light guide panel 80 and therefore into the display elements 81. In certain embodiments, one or more of the reflectors 116, 117 also comprise retro reflectors.

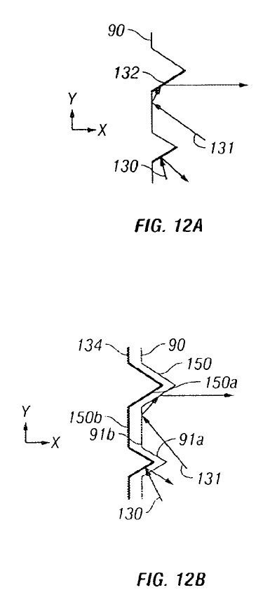

Other configurations are also possible. FIG. 12A illustrates an embodiment in which sloping surface portions or facets 132 of the turning features comprise reflective material, such as metal (e.g., aluminum). The reflective material prevents rays 130 from passing through the sloping surface portion 132. The ray 130 reflects back into the light bar 90 rather than being transmitted therethrough. The outcome might be different if the metal layer were not present and the ray 130 was incident on the sloping surface portion 132 at a non-grazing angle (e.g., smaller than the critical angle as measured with respect to the normal to the sloping surface portion 132). The ray 130, not being totally internally reflected, might otherwise pass therethrough. In the embodiment shown, the sloping surface portions 132 facing the light source 92 are metalized, although other sloping side portions as well as other portions of the side wall, for example, the non-sloping portions, could be metalized. In fact, the entire side 90b could be coated with reflective material in certain embodiments. Ray 131 illustrates that certain rays are directed normal to the length of the light bar 90 and/or toward the light guide panel as in the case where the metallization was not provided.

Metalization, however, may introduce loss. Metal is absorbing. Consequently, at least a portion of the optical energy is lost to the metal reflective coating when light reflects from the coated surface, e.g., the coated sloping surface portions 132. Coating only a portion of the side 90b of the light bar 90, e.g., the sloping surface portions 132, might reduce the loss although may involve more complicated patterning and/or deposition techniques.

FIG. 12B illustrates an alternative embodiment in which a contoured reflector 134 is positioned proximal to the first side 90b of the light bar 90. The contoured reflector 134 includes a plurality of protrusions 150 having sloping surfaces 150a separated by non-sloping portions 150b. Protrusions 150 of the reflective surface 134 can penetrate into indentations 91, e.g., grooves, forming the turning features of the light bar 90. In this manner, the reflective surface of the contoured reflector 134 can come close to the turning film. However, a small air gap or gap filed with another medium, can separate the contoured reflector 134 from the turning film.

Accordingly, in the embodiment shown in FIG. 12B, light incident on the sloping surfaces 91a forming the indentations 91 in the turning film at grazing angles (e.g., greater than the critical angle) can be totally internally reflected instead of being reflected by the reflector 134. Likewise, if the contoured reflector 134 is metal, absorption is reduced. Additionally, as described above, light (e.g., ray 130) incident on a sloping surface portion 91a of the first side of the light bar 90 at small angles relative to the normal (less than the critical angle) would not be total internally reflected and would thus pass through the side of the light bar 90. This light 130, however, can be reflected by the penetrating protruding surfaces 150a of the contoured reflector. The close proximity of the contoured reflector 134 permits the light to be reflected therefrom without much displacement of the ray 130 along the length of the bar 90. The shape of contoured surface of the contoured reflector 134, and in particular of the protrusions, may also be configured to redirect light toward the light guide panel 80.

In the embodiment shown in FIG. 12B, both the contoured reflector 134 and the turning film on the first side 90b of the light bar 90 are substantially similar. For example, both are comprised of portions 150b, 91b which are substantially parallel to the length of the light bar 90 as well as sloping portions 150a, 91a. The contoured surface of the contoured reflector 134, however, need not match the surface 150 of the turning film in other embodiments.

For example, in certain preferred embodiments, the number of protruding surface portions of a reflective surface may be equal to the number of indentations of a light bar. In other embodiments, however, the number of protruding surfaces can be more or less than the number of indentations.

Protruding surface portions of the reflective surface can be substantially aligned with indentations of the light bar. In some embodiments, the apex of the protruding part is approximately aligned with the nadir of the indentation. In other embodiments, the start or edge of the protruding surface is aligned with the start or edge of the indentation. In still other embodiments, alignment can be characterized as one or more distinctive features of the protruding surface portion approximately aligned with one or more corresponding distinctive features of an indentation. Some or all of the protruding surface portions can be aligned with some or all of the indentations.

In various embodiments, some or all of the protruding surfaces can have substantially complementary shapes to some or all of the indentations. The protrusion and indentations can, for example, have substantially similar cross-sections. The protruding surfaces and indentations shown in FIG. 12B are an example of complementary shapes: the protruding surfaces of the reflector 134 form a triangular protrusion, and the indentations on the first side of the light bar 90 form a triangular indentation. The protrusions and indentations need not be of the same size to be of substantially the same shape. If a protruding surface and/or an indentation can be characterized by multiple shapes, some or all of the shapes of the protruding surface can be complementary to some of all of the shapes of the indentation.

The cross-sectional shapes of the indentations and/or the protrusions can comprise, for example, triangles, rectangles, semi-circles, or squares, or other shapes comprised of curved or straight surfaces. In various embodiments, the cross-sectional shapes of the indentations and/or the protrusions comprise a shape with straight, sloped surface portions or facets. In some embodiments, the cross-sectional shapes of the indentations and/or protrusions are substantially triangular.

Protruding surface portions can have a height and indentations can have a depth that is similar or equal. In some embodiments, however, the height of the protruding surface portions can be larger than the depth of the indentations. In other embodiments, the height can be less than the depth. The height and depth can be greater than 10 nm, 100 nm, 1 μm, 10 μm, 100 μm, or 1 mm.

The sloping portions 150a may be of similar thickness to the flat portions 150b on the contoured reflector 134, as illustrated in FIG. 12B. Alternatively, the protrusions may be formed by accumulation of material on a sheet or film such that the protrusions are thicker than the portions 150b therebetween. The latter configuration may have the advantage of added structural stability and ease of manufacturing.

Either or both the turning film and the contoured reflector may be fabricated by embossing (e.g., UV embossing), UV casting, a roll-to-roll process, or other processes. Reflective material may be deposited on the contoured reflector to provide reflectivity.

As discussed above, the contoured reflector 134 can be separated from the light bar 90 by a gap. In preferred embodiments, the gap is filled with a medium characterized by a refractive index less than the refractive index of the light bar 90. The gap allows for light of incident angles greater than the critical angle to be totally internally reflected instead of reflected by the contoured reflective surface 134. As discussed above, if the contoured reflective surface 134 comprises metal, absorption loss can be introduced with reflections therefrom.

In some embodiments, the contoured reflective surface can continuously extend the entire length of the light bar. In other embodiments, the reflective surface can be continuous but shorter or longer than the light bar. In still other embodiments, the reflective surface can be discontinuous and either may or may not extend the entire length of the light bar. The contoured reflector 134 may be included with other reflectors disposed proximal to the first side 90b of the light bar 90. In certain embodiments, the contoured reflector 134 may be integrated with other reflectors, for example, on other sides of the light bar. For example, the contoured reflector 134 may be included with a shroud that is disposed about the light bar and provides multiple reflective surface portions as described above.

The contoured reflective surface, as can the other reflectors described herein, can comprise reflective materials, including but not limited to silver, copper, aluminum, molybdenum, diamond, silicon, alumina, aluminum nitride, aluminum oxide, titanium dioxide, composites of silver, aluminum, molybdenum, diamond, silicon, alumina, aluminum nitride, aluminum oxide, or any other reflective metal. In certain embodiments, a multilayer stack may be employed. In some embodiments, for example, a multilayer interference stack may be employed. The composition of the reflector can be such that a substantial or part of the light incident on the surface is reflected. The reflector can comprise a partially-reflective surface, such that only light of particular incident angles or wavelengths will be reflected.

Other variation in the illumination apparatus are possible. For example multiple light bars may be used. As shown above, the light bar can be a cylindrical shape having the cross-section of a square or rectangle. Alternatively, the light bar could have a circular or oval cross-section or a different or irregular cross-section. Other configurations are also possible.

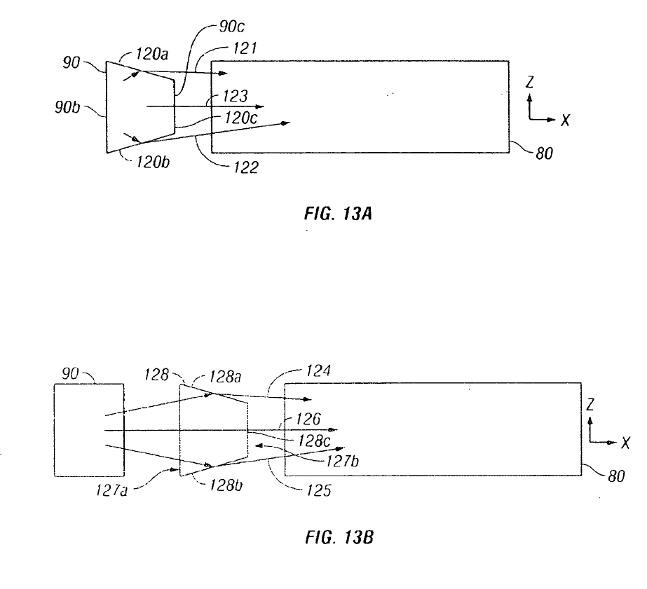

FIG. 13A illustrates an embodiment in which the light bar 90 has a tapered cross section orthogonal to the length of the light bar 90. This tapered cross section provides for increased light collimation.

As shown in FIG. 13A, for example, the first side 90b of the light bar 90 comprises a substantially planar surface. The second side 90c that is more proximal to the light guide panel 80 comprises a surface that is multi-faceted and includes a plurality of planar surface portions. In particular, the second side 90c includes first and second sloping portions 120a, 120b that slope toward a central portion 120c The first and second sloping portions 120a, 120b, as well as the central portion 120c are each substantially planar. As a result, the light bar 90 has a thickness that is reduced towards the light guide panel 80. The configuration of the second side 90c refracts light so as to increase collimation of light directed into the light guide panel.

The sloping surface portions 120a, 120b of the light bar 90 refract incident rays 121, 122 away from normal of these surface portions such that the angle of refraction exceeds the angle of incidence as the rays pass from the light bar 90 (with a higher index of refraction) to a medium with a lower index of refraction. This refraction of rays 121 and 122 cause the rays to be less diverging. The rays 121 and 122 are instead directed more parallel to the normal of the planar central surface portion 120c which is coincident with rays 123. Ray 123 propagates along the normal and is not redirected. Accordingly, this tapered cross section of the light bar 90, wherein the light bar 90 is tapered from the first side 90b to the second side 90c, increases the collimation of the rays by reducing their divergence.

Although not depicted, the tapered light bar 90 may comprise the turning microstructure as described above. For example, the left side 90b of the light bar 90 may comprise turning microstructure.

In alternative embodiments, surface portions 120a, 120b, 120c need not be planar. In certain embodiments, for example, one or more of theses surface portions 120a, 120b, 120c may be curved. In other embodiments, one or more of these surface portions 120a, 120b, 120c may themselves be multifaceted.

In some embodiments, a substantially transmissive elongate optical coupling member or optical coupler 128 is disposed between the light bar 90 and the light guide panel 80 as illustrated in FIG. 13B. In the embodiment shown, the light bar 90 may have a substantially rectangular cross-section. The elongate optical coupling member 128, however, has a cross-section that is tapered from a first side 127a closer to the light bar 90 to a second side 127b closer to the light guide panel. This taper increases the collimation of light from the light bar 90 that is injected into the light guide panel 80.

As shown in FIG. 13B, for example, the first side 127a of the elongate optical coupler 128 comprises a surface that is substantially planar. The second side 127b is multi-faceted and includes a plurality of planar surface portions. In particular, the second side 127b comprises a surface having first and second sloping portions 128a, 128b that slope toward a central portion 128c The first and second sloping portions 128a, 128b, as well as the central portion 128c are each substantially planar. As a result, the optical coupler 128 has a thickness that is reduced towards the light guide panel 80. The configuration of the surface on the second side 127b refracts light so as to increase collimation of light directed into the light guide panel 80.

The sloping surface portions 128a, 128b of the coupler 128 refract incident rays 124, 125 away from the normal of these surface portions such that the angle of refraction exceeds the angle of incidence as the rays pass from the optical coupler (with a higher index of refraction) to a medium with a lower index of refraction. This refraction of rays 124 and 125 cause the rays to be less diverging. The rays 124 and 125 are instead directed more parallel to the normal to the central surface portion 128c, which is coincident with rays 126. Ray 126 propagates along this normal and is not refracted. Accordingly, this tapered cross section of the optical coupler 128, wherein the coupler is tapered from the first side 127a to the second side 127b, increases the collimation of the rays by reducing their divergence. As described above, light that is collimated upon entry into the light guide panel 80 provides superior lighting characteristics in some circumstances than light that is not collimated.

In alternative embodiments, surface portions 128a, 128b, 128c need not be planar. In certain embodiments, for example, one or more of theses surface portions 128a, 128b, 128c may be curved. In other embodiments, one or more of these surface portions 128a, 128b, 128c may themselves be multifaceted.

A wide variety of variations are possible. Films, layers, components, and/or elements may be added, removed, or rearranged. Additionally, processing steps may be added, removed, or reordered. Also, although the terms “film” and “layer” have been used herein, such terms as used herein may include film stacks and multilayers. Such film stacks and multilayers may be adhered to other structures using adhesive or may be formed on other structures using deposition or in other manners.

Moreover, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

1. An illumination apparatus comprising:
a light bar having a first end for receiving light from a light source, said light bar comprising material that supports propagation of said light along the length of the light bar;
a plurality of indentations in the light bar on a first side of the light bar, the indentations configured to turn at least a substantial portion of the light incident on the first side and to direct said portion of light out a second opposite side of the light bar, said indentations including sloping sidewalls that reflect light by total internal reflection out said second opposite side of the light bar;
at least one contoured reflective surface comprising a plurality of protruding surface portions, said protruding surface portions reflecting light transmitted through said sloping sidewalls; and
a gap between the light bar and the at least one contoured reflective surface, wherein said protruding surface portions penetrate into said indentations.

2. (canceled)

3. The illumination apparatus of claim 1, wherein said protruding surface portions of said contoured reflective surface are substantially aligned with said indentations on said light bar.

4. The illumination apparatus of claim 1, wherein the protruding surface portions and said indentations have substantially complementary shapes.

5. The illumination apparatus of claim 1, wherein the protruding surface portions have a height and said indentations have a depth, said height being larger than said depth.

6. The illumination apparatus of claim 1, wherein said light source comprises a light emitting diode.

7. The illumination apparatus of claim 1, wherein the protruding surface portions have a height and said indentations have a depth, said height and depth being greater than 100 nm.

8. (canceled)

9. The illumination apparatus of claim 1, wherein the gap is filled with a medium having a refractive index less than the refractive index of the light bar.

10. The illumination apparatus of claim 1, wherein the gap is filled with gas.

11. The illumination apparatus of claim 1, wherein the gap is filled with air.

12. The illumination apparatus of claim 1, further comprising a light guide panel disposed with respect to the second side of the light bar to receive light turned by said indentations and directed out of said second opposite side of the light bar.

13. The illumination apparatus of claim 12, further comprising a coupling optic between the light bar and the light guide panel.

14. The illumination apparatus of claim 12, wherein the light guide panel is disposed with respect to a plurality of spatial light modulators to illuminate the plurality of spatial light modulators.

15. The illumination apparatus of claim 14, wherein the plurality of spatial light modulators comprises an array of interferometric modulators.

16. The illumination apparatus of claim 14, further comprising:
a display;
a processor that is configured to communicate with said display, said processor being configured to process image data; and
a memory device that is configured to communicate with said processor.

17. The illumination apparatus of claim 16, further comprising a driver circuit configured to send at least one signal to the display.

18. The illumination apparatus of claim 17, further comprising a controller configured to send at least a portion of the image data to the driver circuit.

19. The illumination apparatus of claim 16, further comprising an image source module configured to send said image data to said processor.

20. The illumination apparatus of claim 19, wherein the image source module comprises at least one of a receiver, transceiver, and transmitter.

21. The illumination apparatus of claim 16, further comprising an input device configured to receive input data and to communicate said input data to said processor.

22. The illumination apparatus of claim 1, wherein the light bar includes a film disposed on the first side of the light bar, said indentations formed in said film.

23. The illumination apparatus of claim 1, wherein the indentations comprise triangular grooves having substantially triangular cross-sections.

24. A method of manufacturing an illumination apparatus, comprising:
providing a light bar having a first end for receiving light from a light source, said light bar comprising material that supports propagation of said light along the length of the light bar;
providing a plurality of indentations in the light bar on a first side of the light bar, the indentations configured to turn at least a substantial portion of the light out a second opposite side of the light bar, said indentations including sloping sidewalls that reflect light by total internal reflection out said second opposite side of the light bar; and
disposing at least one contoured reflective surface comprising a plurality of protruding surface portions such that said protruding surface portions of said contoured reflective surface penetrate into said indentations on said light bar, said protruding surface portions reflecting light transmitted through said sloping sidewalls; and
including a gap between the light bar and the at least one contoured reflective surface.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. An illumination apparatus comprising:
means for supporting propagation of said light along the length of said propagation supporting means, said light propagation supporting means including means for receiving light from a means of producing light;
means for turning light incident on a first side of the propagation supporting means and directing said portion of light out a second opposite side of said propagation supporting means, said turning means disposed on the first side of said propagation supporting means, said turning means comprising first means for deflecting light that reflects light by total internal reflection out said second opposite side of the propagation supporting means; and
means for reflecting light comprising a second means for deflecting light, said second light deflecting means reflecting light transmitted through said first light deflecting means, said second light deflecting means penetrating into said means for turning light; and
means for propagating light between the means for turning light and the reflecting means.

43. (canceled)

44. (canceled)

45. (canceled)

46. (canceled)

47. (canceled)

48. (canceled)

49. (canceled)
